(19) United States
(12) Patent Application Publication
(10) Pub. No.: US 2020/0308880 A1
(43) Pub. Date: Oct. 1, 2020

(54) PADDLE LOCK

(71) Applicant: CHIA-CHENG LIN, YUANLIN CITY (TW)

(72) Inventor: CHIA-CHENG LIN, YUANLIN CITY (TW)

(21) Appl. No.: 16/371,241

(22) Filed: Apr. 1, 2019

(51) Int. Cl. E05B 81/06; E05B 81/34; E05B 81/14; E05B 79/04; E05B 79/12

(52) U.S. Cl. CPC E05B 81/06; E05B 81/34; E05B 79/12; E05B 79/04; E05B 81/14

(57) ABSTRACT

A paddle lock has a body, a lever, a latch, a locking bolt, a bolt driving device, and a lock device. The lever is pivotally mounted on the body and has a pushing arm. The latch has a pushed protrusion selectively abutting against and pushed by the pushing arm of the lever. The locking bolt is mounted slidably in the body and has an abutting arm. The abutting arm extends toward the pushing arm to selectively abut the pushing arm. The bolt driving device is mounted in the body and is connected with the locking bolt to push the locking bolt to extend out of the body or to retract the locking bolt into the body. The lock device is mounted on the body and is connected with the bolt driving device.

### BACKGROUND OF THE INVENTION

### 1. Field of the Invention

The present invention relates to a paddle lock, and more particularly to a paddle lock that has a simplified structure.

### 2. Description of Related Art

A paddle lock is usually mounted on a door panel of a station wagon. A conventional paddle lock substantially comprises a body, a lever, a latch, a locking bolt, a bolt driving device, a latch lock, and a bolt lock. The lever is pivotally mounted on the body. The latch is mounted retractably in the body and is connected with the lever. The locking bolt is mounted slidably in the body. The bolt driving device is mounted in the body and is connected with the locking bolt to retract the locking bolt into the body. The latch lock is mounted on the body and is connected to the lever to lock the lever. The bolt lock is mounted on the body and is connected with the bolt driving device to lock the bolt locking device.

When the lever is pivoted, the latch can be retracted into the body. Thus, the paddle lock can be unlocked. In addition, when the locking bolt is driven to extend out of the body by the bolt driving device, the paddle lock can be locked to keep the door panel from being opened.

When the latch lock is in a locked position, the lever is kept from being pivoted. Thus, the latch can be kept from being retracted into the body and the paddle lock is kept in the locked position. When the bolt lock is locked, the bolt driving device is locked and the locking bolt is kept from being retracted into the body. Accordingly, the paddle lock is kept in the locked position.

However, to lock the latch and the locking bolt of the conventional paddle lock, a latch lock and a bolt lock are necessary and have to be mounted on the body at the same time. Therefore, the structure of the conventional paddle lock is complicated, and the cost for manufacturing the conventional paddle lock is high.

To overcome the shortcomings, the present invention tends to provide a paddle lock to mitigate or obviate the aforementioned problems.

### SUMMARY OF THE INVENTION

The main objective of the invention is to provide a paddle lock that has a simplified structure and has a single lock to lock a latch and a locking bolt at the same time.

The paddle lock has a body, a lever, a latch, a locking bolt, a bolt driving device, and a lock device. The lever is pivotally mounted on the body and has a pushing arm formed on and protruding from a bottom of the lever. The latch is mounted retractably in the body and has a pushed protrusion formed on and protruding from the latch and selectively abutting against and pushed by the pushing arm of the lever. The locking bolt is mounted slidably in the body and has an abutting arm. The abutting arm is formed on and protrudes from the locking bolt and extends toward the pushing arm of the lever to selectively abut the pushing arm of the lever. The bolt driving device is mounted in the body and is connected with the locking bolt to push the locking bolt to extend out of the body or to retract the locking bolt into the body. The lock device is mounted on the body and is connected with the bolt driving device.

Other objects, advantages and novel features of the invention will become more apparent from the following detailed description when taken in conjunction with the accompanying drawings.

### BRIEF DESCRIPTION OF THE DRAWINGS

FIG. 1 is a paddle lock in accordance with the present invention;

FIG. 2 is an enlarged perspective view of the paddle lock in FIG. 1;

FIG. 3 is a partially exploded perspective view of the paddle lock in FIG. 1;

FIG. 4 is another partially exploded perspective view of the paddle lock in FIG. 1;

FIG. 5 is a top view of the paddle lock in FIG. 1;

FIG. 6 is a side view in partial section of the paddle lock along the line 6-6 in FIG. 5; and

FIG. 7 is an operational side view in partial section of the locking bolt in FIG. 6.

### DETAILED DESCRIPTION OF PREFERRED EMBODIMENT

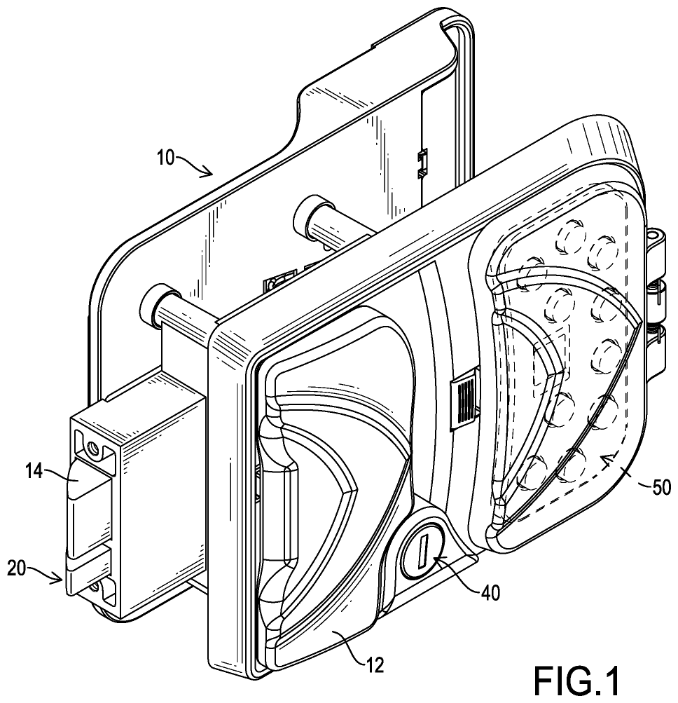

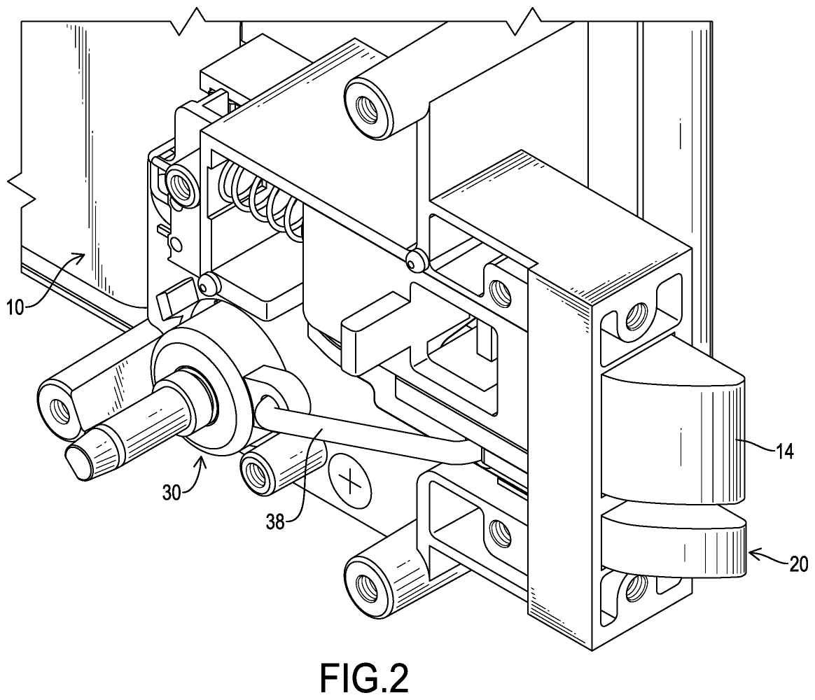

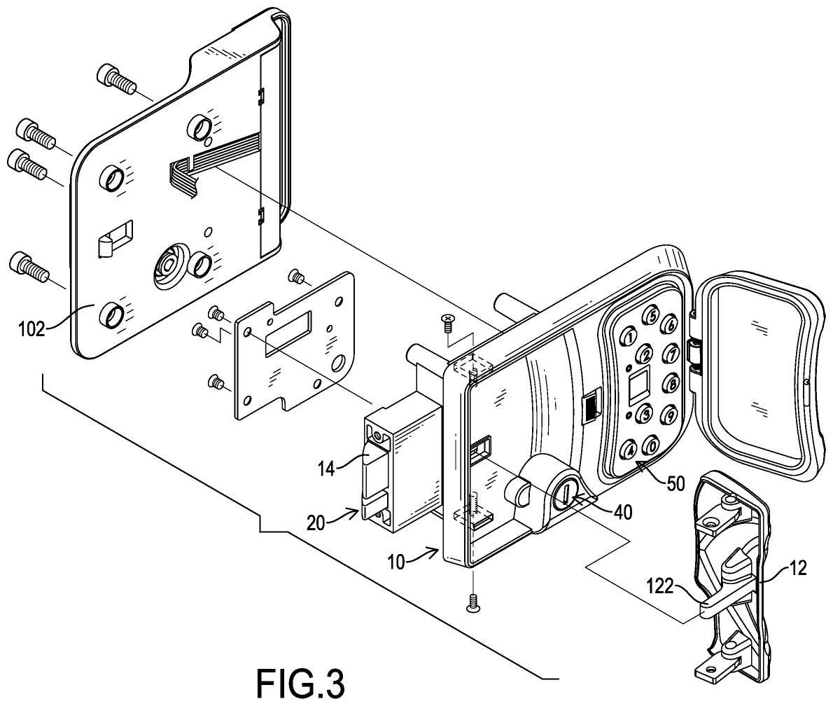

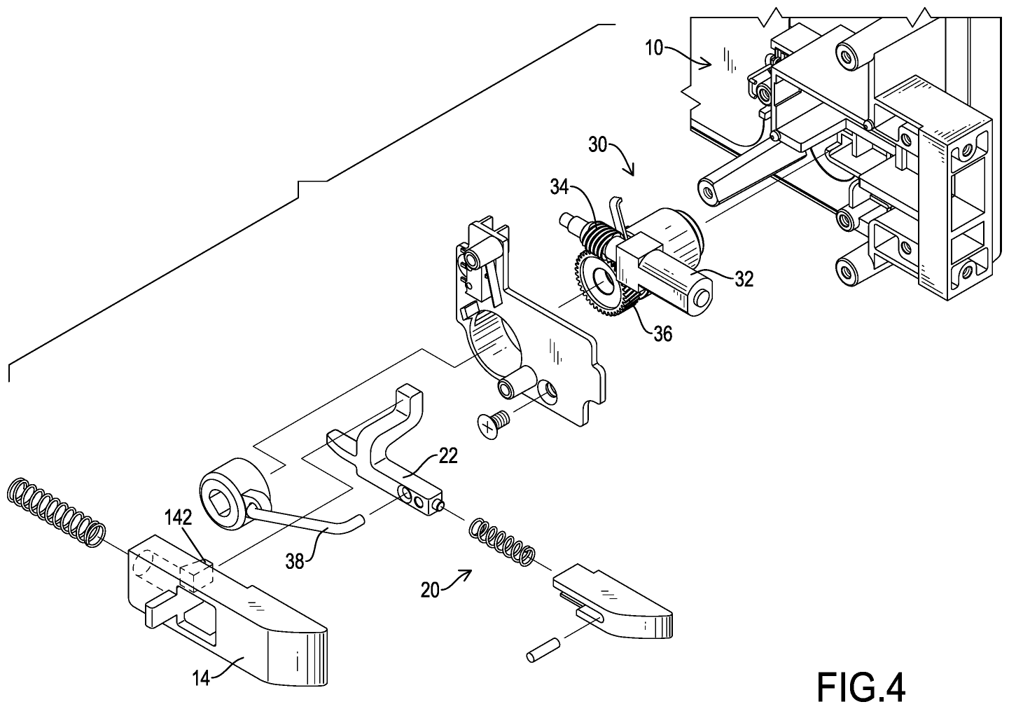

With reference to FIGS. 1 to 4, a paddle lock in accordance with the present invention comprises a body 10, a lever 12, a latch 14, a locking bolt 20, a bolt driving device 30, and a lock device 40,50. The body 10 is adapted to be mounted on a door panel of a vehicle, such as a station wagon. The lever 12 is mounted pivotally on the body 10. The lever 12 has a pushing arm 122 formed on and protruding from a bottom of the lever 12 and extending into the body.

The latch 14 is mounted retractably in the body 10 and has a pushed protrusion 142 formed on and protruding from the latch 14 and selectively abutting against and pushed by the pushing arm 122 of the lever 12.

The locking bolt 20 is mounted slidably in the body 10 and has an abutting arm 22 formed on and protruding from the locking bolt 20 and extending toward the pushing arm 122 of the lever 12 to selectively abut the pushing arm 122 of the lever 12.

The bolt driving device 30 is mounted in the body 10 and is connected to the locking bolt 20 to push the locking bolt 20 to extend out of the body 10 or retract the locking bolt 20 into the body 10. The bolt driving device 30 may be electric and is electrically connected with a circuit board 102 that is mounted in the body 10. The bolt driving device 30 comprises a motor 32, a worm rod 34, a worm wheel 36, and a connection rod 38. The motor 32 is mounted in the body 10. The worm rod 34 is connected with and driven by the motor 32. The worm wheel 36 is mounted rotatably in the body 10 and is engaged with the worm rod 34. The connection rod 38 is connected between the worm wheel 36 and the bolt rod 22 of the locking bolt 20. Accordingly, when the motor 32 is switched on, the worm wheel 36 is driven to rotate by the transmission of the worm rod 34. When the worm wheel 36 is rotating, the locking bolt 20 is driven to slide to move relative to the body 10 by the transmission of the connection rod 38.

The lock device 40, 50 is mounted on the body to lock the bolt driving device 30. In practice, the lock device 40 is a key lock cylinder that is connected with the worm wheel 36. When a correct key is inserted into the key lock cylinder, the worm wheel 36 can be rotated to retract the locking bolt 30 into the body 10 and to unlock the paddle lock. Alternatively, the lock device 50 is an electric lock device, such as an electric code lock or a fingerprint lock, is mounted on the body, and is electrically connected with the circuit board 102. When the electric lock device 50 is unlocked by a correct code or an authorized fingerprint, an electrical signal can be transmitted to the circuit board to drive the motor 32 to rotate. Consequently, the locking bolt 20 can be retracted into the body 10 to unlock the locking bolt 20.

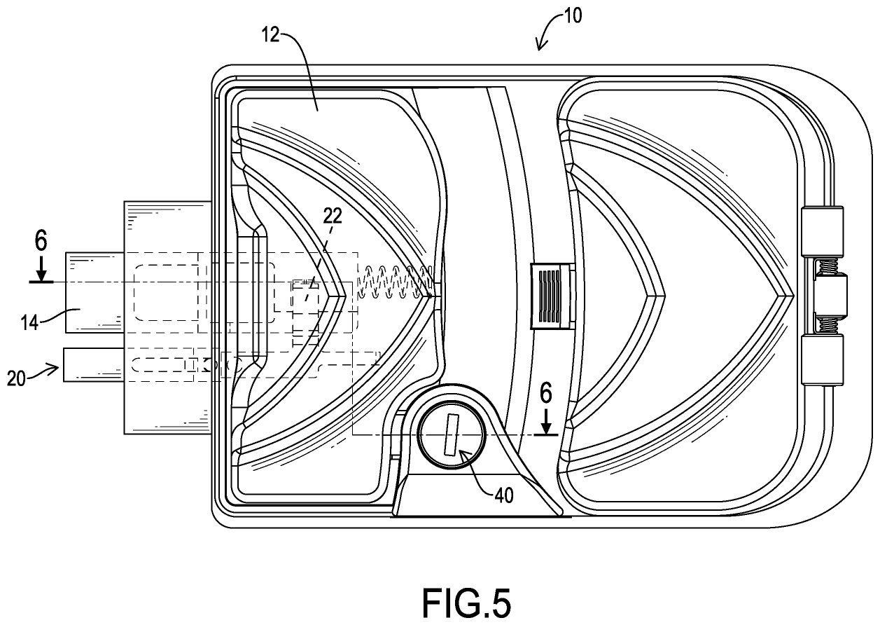

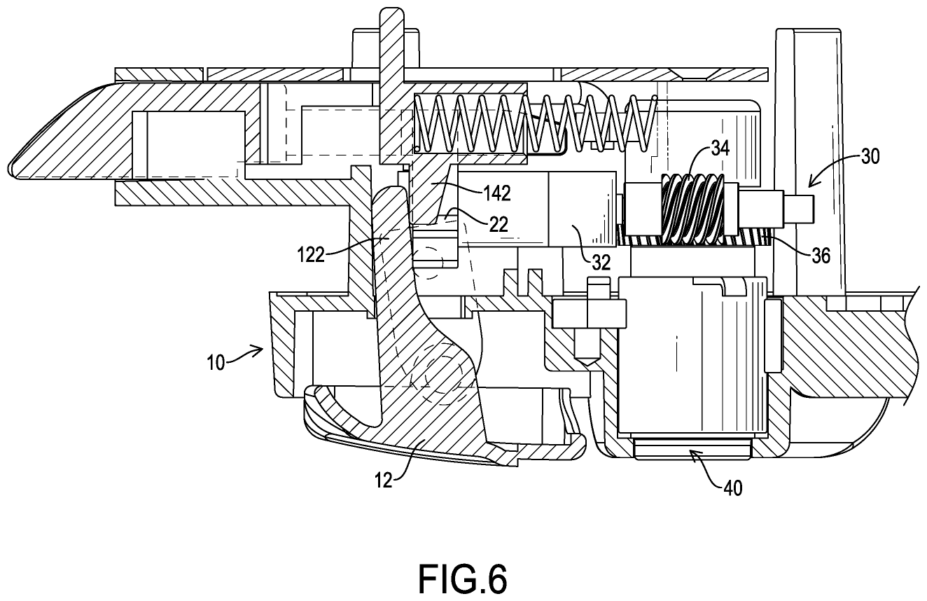

With reference to FIGS. 5 and 6, when the locking bolt 20 is in the locked position and is locked by the lock device 40,50, the locking bolt extends out of the body 10 and extends into a bolt hole defined in a door frame of the vehicle. At this time, the abutting arm 22 abuts against the pushing arm 122 of the lever 12. Consequently, the lever 12 is kept from being pivoted relative to the body 10 due to the abutment with the abutting arm 22 on the locking bolt 20. Accordingly, the latch 14 can be kept from being retracted into the body 10 and is also locked. Therefore, only one single lock device 40,50 is necessary for locking the latch 14 and the locking bolt 20 at the same time such that the structure of the paddle lock can be simplified and the cost for manufacturing the paddle lock can also be reduced.

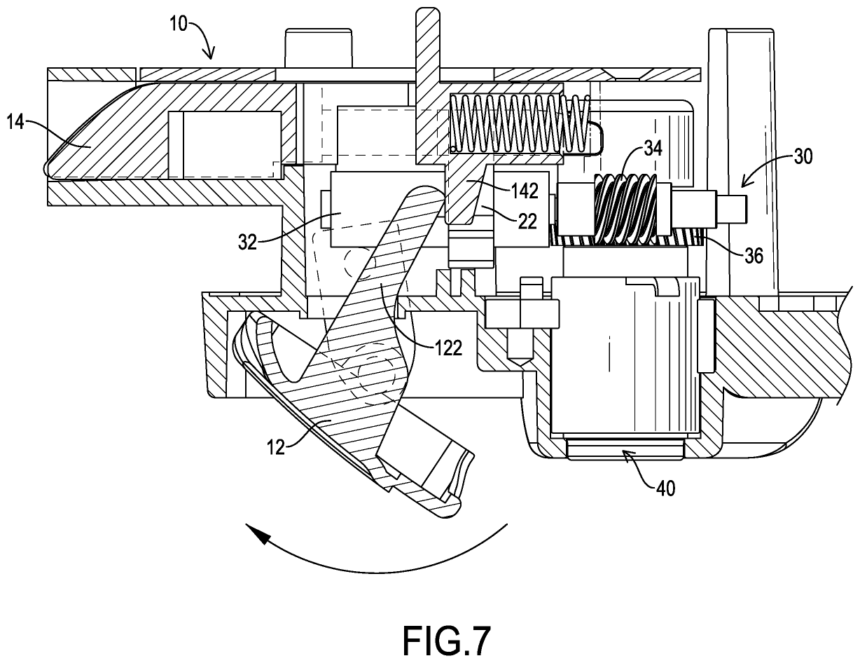

To unlock the paddle lock, with further reference to FIG. 7, the lock device 40, 50 is unlocked, and the locking bolt 20 can be retracted into the body 10 by the bolt driving device 30. Consequently, the abutting arm 22 will leave the position where the abutting arm 22 abuts against the pushing arm 122 of the lever 12. Thus, the lever 12 is allowed to be pivoted relative to the body 10, and the pushed protrusion 142 on the latch 14 is pushed by the pushing arm 122 on the lever 12. The latch 14 can be retracted into the body 10 to unlock the paddle lock. Accordingly, to unlock the paddle lock in accordance with the present invention is convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A paddle lock comprising:
a body;
a lever pivotally mounted on the body and having a pushing arm formed on and protruding from a bottom of the lever;
a latch mounted retractably in the body and having a pushed protrusion formed on and protruding from the latch and selectively abutting against and pushed by the pushing arm of the lever;
a locking bolt mounted slidably in the body and comprising
an abutting arm formed on and protruding from the locking bolt and extending toward the pushing arm of the lever to selectively abut the pushing arm of the lever;
a bolt driving device mounted in the body and connected with the locking bolt to push the locking bolt to extend out of the body or to retract the locking bolt into the body; and
a lock device mounted on the body and connected with the bolt driving device.

2. The paddle lock as claimed in claim 1, wherein
the body further has a circuit board mounted in the body; and
the bolt driving device is electrically connected with the circuit board and comprises
a motor mounted in the body;
a worm rod connected with and driven by the motor;
a worm wheel mounted rotatably in the body and engaged with the worm rod; and
a connection rod connected between the worm wheel and the locking bolt.

3. The paddle lock as claimed in claim 2, wherein the lock device is a key lock cylinder and is connected with the worm wheel.

4. The paddle lock as claimed in claim 2, wherein the lock device is an electric lock device, is mounted on the body, and is electrically connected with the circuit board.

5. The paddle lock as claimed in claim 4, wherein the lock device is an electric code lock.

6. The paddle lock as claimed in claim 4, wherein the lock device is a fingerprint lock.
